(19) United States
(12) Patent Application Publication
(10) Pub. No.: US 2026/0104928 A1
(43) Pub. Date: Apr. 16, 2026

(54) HIERARCHICAL CREDIT-BASED RESOURCE MANAGEMENT

(71) Applicant: Hewlett Packard Enterprise Development LP, Spring, TX (US)

(72) Inventors: Christopher Michael Brueggen, Allen, TX (US); Vincent E. Chang, Irvine, CA (US)

(21) Appl. No.: 18/915,060

(22) Filed: Oct. 14, 2024

(51) Int. Cl. G06F 9/50; G06F 13/28

(52) U.S. Cl. CPC G06F 9/5027; G06F 13/28; G06F 2213/28

(57) ABSTRACT

One aspect may provide a resource-management system. The system includes a resource-management hierarchy comprising higher and lower levels of resources, a plurality of credit-management circuits, a respective credit-management circuit to manage credits associated with a resource for the set of traffic classes, and a command queue comprising a plurality of to-be-processed commands mapped to a set of traffic classes. The system includes a higher-level arbitration circuit to select, among the plurality of to-be-processed commands, a command to process based on credit information associated with the higher-level resources for the set of traffic classes, a set of fixed-sized traffic-class-specific queues corresponding to the set of traffic classes to queue processed commands, and a lower-level arbitration circuit to select a queue from the set of fixed-sized traffic-class-specific queues to dequeue for next-stage processing based on credit information associated with the lower-level resources for the set of traffic classes.

### STATEMENT OF GOVERNMENT-FUNDED RESEARCH

This invention was made with Government support under Contract Number H98230-23-C-0350 awarded by the Maryland Procurement Office. The Government has certain rights in this invention.

### BACKGROUND

### Field

This disclosure is generally related to resource management. More specifically, this disclosure is related to applying hierarchical credit-based resource management in the transmit pipeline of a network interface card (NIC).

### Related Art

Scatter-gather Direct Memory Access (DMA) is a sophisticated technique employed in applications demanding high bandwidth and low latency data transfers between memory and peripherals, such as high-performance computing (HPC) systems. This method offers significant advantages over traditional DMA approaches. Unlike conventional DMA, which is limited to transferring data in a single, contiguous block, scatter-gather DMA enables the transfer of non-contiguous memory blocks, thus providing greater flexibility in memory usage and can lead to substantial performance improvements.

On a network interface controller (NIC) supporting S-G DMA operations, processing host-side commands (e.g., commands issued by applications running on the host) may involve consuming various types of resources at various processing stages. It is challenging to guarantee the fair use of the resources among different traffic classes (TCs).

### BRIEF DESCRIPTION OF THE FIGURES

FIG. 1 illustrates an example schematic diagram of a credit-management circuit, according to one aspect of the instant disclosure.

FIG. 2 illustrates the schematic diagram of an example hierarchical resource-management system, according to one aspect of the instant disclosure.

FIG. 3 illustrates an example of managing various resources on a network interface card (NIC) hierarchically, according to one aspect of the instant disclosure.

FIG. 4 presents a flowchart illustrating an example process for managing a plurality of resources on a network interface controller (NIC), according to one aspect of the instant disclosure.

FIG. 5 illustrates an example network interface controller (NIC), according to one aspect of the instant application.

FIG. 6 illustrates a computer-readable medium that facilitates the operation of the hierarchical-resource-management system, according to one aspect of the instant application.

In the figures, like reference numerals refer to the same figure elements.

### DETAILED DESCRIPTION

To ensure fair resource utilization on a network interface controller (NIC) across all Traffic Classes (TCs), it is essential to implement a metering system that restricts resource usage to prevent overuse. However, the implementation of Scatter-Gather (S-G) DMA introduces complexities in resource allocation due to its hierarchical nature of command processing. The hierarchical processing of host-side commands in S-G DMA systems involves multiple stages, each consuming different types and amounts of resources. This multi-stage approach makes it challenging to predict in advance the exact resource requirements for a given command. For instance, the initial command itself consumes buffer resources, such as a command first in, first out (FIFO) queue. As processing progresses, the command may lead to the construction of one or more packets through S-G DMA instructions, each utilizing additional NIC resources like packet buffers and connection/tracking structures. Further complicating the resource allocation is the breakdown of S-G DMA instructions into multiple smaller DMA operations. Each of these operations requires various resources, including instruction tracker entries, DMA tracking resources, address translation capabilities, and PCIe link bandwidth. The dynamic nature of this process means that the resource needs can vary significantly based on the specific characteristics of each command and the resulting data transfer operations. In general, it is challenging to implement a single point of arbitration that can guarantee the fair use of all resources among all traffic classes.

In some aspects of the instant disclosure, the technical problem of managing access to NIC resources among traffic classes may be solved using a hierarchical resource-management scheme to enable the local control of resource consumption by each Traffic Class (TC). Depending on the consumers (e.g., requests, response, S-G DMA instructions, etc.), different resources (e.g., packet buffers, trackers, etc.) may be grouped into different resource domains managed in a hierarchy of multiple levels, with each level including one or more resource domains. Resource management at a lower hierarchy level is hidden from resource management at a higher level by implementing a set of fixed-sized per-TC queues at the interface between the two levels.

This disclosure also describes a credit-management circuit for credit-based resource management. This credit-management circuit includes a number of “take” and “return” interfaces corresponding to different command-processing stages (or control function), where each stage or function may consume or return a certain number of credits. The credit-management circuit may also be configured to specify the total number of credits for the resource, the number of credits reserved for each TC, and the credit limit for each TC. The credit-management circuit may also output, for each TC, a credit available signal and a throttle signal.

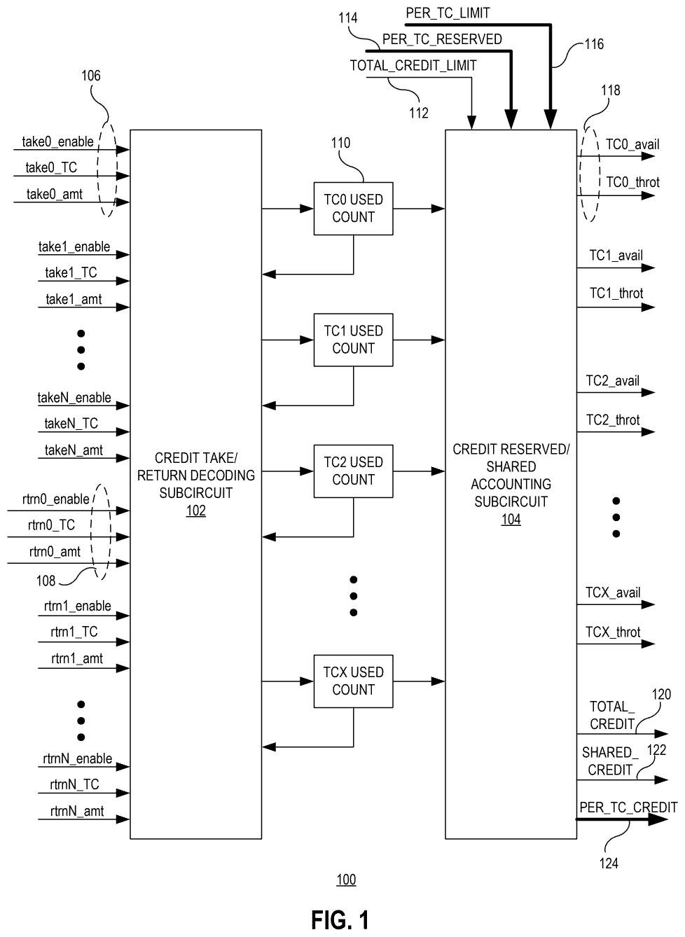

FIG. 1 illustrates an example schematic diagram of a credit-management circuit, according to one aspect of the instant disclosure. The credit-management circuit may be a generic circuit that can be used to manage different types of resources, including but not limited to command/packet buffer resources, address translation resources, link bandwidth, tracker resources, etc. In the example shown in FIG. 1, credit-management circuit 100 may include a credit take/return decoding subcircuit 102 and a credit reserved/shared accounting subcircuit 104.

Credit take/return decoding subcircuit 102 may be responsible for determining the number of credits taken or returned by each consumer of the credits. In some aspects, as the command traverses different processing stages, each control function (e.g., a control function for queuing the command, a control function for processing the S-G DMA instruction, a control function for performing a DMA operation, etc.) may speculatively request a certain number of credits (which is often more than what is needed). After processing, unused resources may be returned by the control function.

Credit take/return decoding subcircuit 102 may include a plurality of credit-take interfaces, such as a credit-take interface 106. In the example shown in FIG. 1, credit take/return decoding subcircuit 102 may include N+1 credit-take interfaces, supporting up to N+1 credit-take instances used to consume the same resource, such as instance No. 0, instance No. 1, up to instance No. N. In some aspects, each credit-take interface may be used by a particular control function (also referred to as a credit consumer) to request a specified number of credits for a particular TC. In further aspects, the same control function (e.g., the same S-G DMA instruction-processing function) may consume credits of the same resource (e.g., the tracker resource) at different stages of the S-G DMA pipeline and may use different credit-take interfaces to take credits.

Each credit-take interface may include multiple inputs, such as an enable or valid input for enabling the interface, a TC input specifying the TC, and an amount input indicating the number of credits being taken. Using credit-take interface 106 as an example, the take0_enable input allows the control function to indicate that inputs to this interface are valid in the current clock cycle. The take0_TC input indicates the TC associated with the credits being taken. For example, if the credits taken by instance No. 0 are used to process a command belonging to a particular TC, the take0_TC input should specify that particular TC. The take0_amt input indicates the number of credits being taken by the requester.

Credit take/return decoding subcircuit 102 may include a plurality of credit-return interfaces, such as a credit-return interface 108. Like the credit-take interfaces, each credit-return interface may be used by a credit-return instance (e.g., instance No. 0, instance No. 1, up to instance No. N) to return unused or released credits. In many cases, the credits may be taken by a control function speculatively, where the control function may take more credits from resources than what is needed. In such a case, after the control function consumes its needed credits, unused credits may be returned via a corresponding credit-return interface. Moreover, after the resource is released (e.g., after a tracker entry is cleared), released credits may be returned via a different credit-return interface.

Each credit-return interface may include multiple inputs, such as an enable or valid input for enabling the interface, a TC input specifying the TC, and an amount input indicating the number of credits being returned. Using credit-return interface 108 as an example, the rtrn0_enable input allows a control function to indicate that inputs to this interface are valid in the current clock cycle. The rtrn0_TC input indicates the TC associated with the credits being returned. For example, if the credits returned by instance No. 0 were used previously to process a command belonging to a particular TC, the rtrn0_TC input should specify that particular TC. The rtrn0_amt input indicates the number of credits being returned. The returned credits may be unused credits or released credits.

In some aspects, credit-management circuit 100 may further include a plurality of per-TC credit-counting subcircuits, such as subcircuit 110. Each per-TC credit-counting subcircuit may compute, for a specific traffic class, credits taken and returned from all credit consumers and output a total number of consumed credits. For example, credit-counting subcircuit 110 may first identify the take interfaces that are taking credits for TC0 and then add the number of taken credits specified by the identified take interfaces to obtain the total number of credits taken for TC0. Similarly, credit-counting subcircuit 110 may also identify the return interfaces that are returning credits on behalf of TC0 and then add the number of returned credits specified by the identified returned interfaces to obtain the total number of credits returned for TC0. Credit-counting subcircuit 110 may then subtract the total returned credits from the total number of credits in use and add the total taken credits to the total number of credits in use to obtain the number of credits currently used by TC0. The same process may be performed for all TCs.

In some aspects, the system may specify an overall credit limit for the resource and reserve a predetermined number of credits for each TC. A shared credit pool is defined as the difference between the total number of reserved credits and the overall credit limit. For each TC, credits may be taken from its reserved pool first. If credits reserved for a particular TC are exhausted, credits from the shared pool may be taken. On the other hand, returned credits are first deposited into the shared pool and will be returned to the per-TC reserved pool after the shared pool is full.

Credit reserved/shared accounting subcircuit 104 is responsible for keeping track of credits in the shared credit pool as well as the per-TC reserved pools. In some aspects, credit reserved/shared accounting subcircuit 104 may receive a number of configuration inputs (e.g., from the upper-level software allocating resources), including a total_credit_limit input 112 specifying the total number of credits for the given resource, a set of per_TC_reserved inputs 114 specifying the number of reserved credits for each TC, and a set of per_TC_limit inputs 116 specifying the credit limit for each TC. Note that the maximum number of credits in the shared pool may be the difference between the total number of credits and the sum of reserved credits of all TCs. Each TC may take credits from its reserved pool and the shared pool when needed. However, the total number of credits taken by a TC should not exceed the credit limit set for that TC.

As shown in FIG. 1, credit reserved/shared accounting subcircuit 104 may receive the outputs of the per-TC credit-counting subcircuits and determine whether there are credits available for taken by each TC. For example, credit reserved/shared accounting subcircuit 104 may compare the number of credits used by a particular TC with the number of credits reserved for that TC and the credit limit to determine whether credits are available for the TC. In the example shown in FIG. 1, credit reserved/shared accounting subcircuit 104 may generate a pair of outputs for each TC, such as an output pair 118. Each output pair may include a credit-available output and a credit-throttle output. For example, output pair 118 may include a TC0_avail output indicating the availability of credits for TC0. In one example, the credit-available output may be a binary signal, with one indicating that credits are available and “0” indicating that no credit is available for that TC. Output pair 118 also includes a TC0_throt output indicating that the available credits for TC0 are below a predetermined threshold and that the credit consumption by TC0 should be throttled.

Credit reserved/shared accounting subcircuit 104 may generate additional outputs, including a total_credit output 120 indicating the total number of available credits for that particular resource, a shared_credit output 122 indicating the number of available credits in the shared pool, and a set of per_TC_credit output 124 indicating the number of available credits in the reserved pool for each TC.

Outputs of credit reserved/shared accounting subcircuit 104 may be used by an arbitration circuit to make an arbitration decision. For example, when S-G DMA instructions associated with multiple TCs are competing to access the S-G DMA engine, the arbitration circuit may fairly distribute the S-G DMA resources (e.g., S-G DMA tracker structures) among the TCs. As discussed previously, processing a host-side command may involve multiple resources at multiple processing stages. A command associated with a particular TC may be successfully processed if and only if sufficient credit is available for each resource at each stage. More specifically, at each stage or hierarchy level, the resource may be managed locally. Moreover, at the interface from the higher hierarchy level to the lower hierarchy level, a set of fixed-sized per-TC queues may be introduced to queue the commands such that the complexity of the resource management at the lower hierarchy level is hidden from the higher level because the higher-level arbitration makes decisions based solely on the status of those fixed-sized per-TC queues.

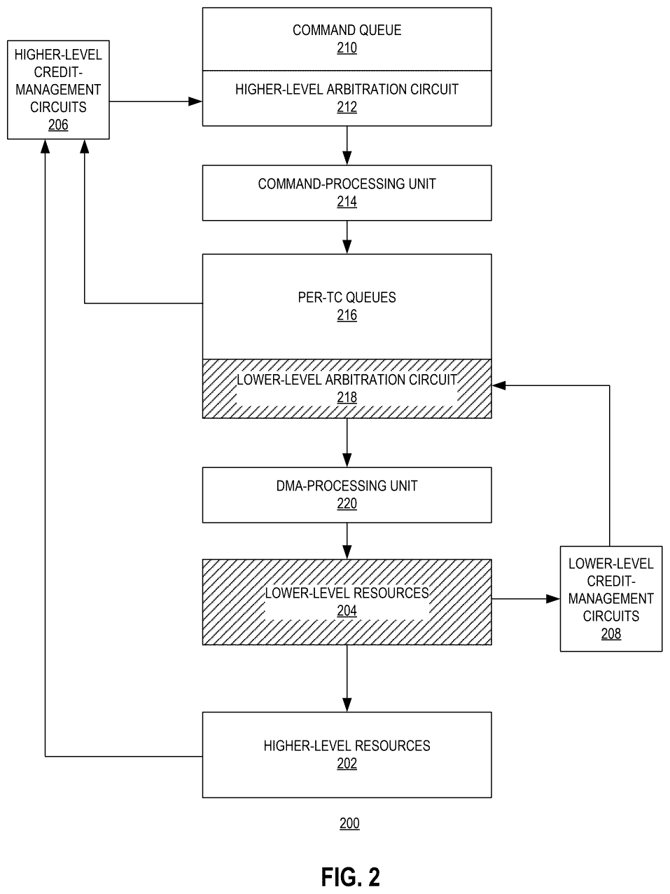

FIG. 2 illustrates the schematic diagram of an example hierarchical resource-management system, according to one aspect of the instant disclosure. Note that this schematic diagram is used to illustrate the concept of managing resources hierarchically and may not include every component needed for resource management. The example shown in FIG. 2 may be used to manage resources needed for processing host-side commands. In practice, the disclosed hierarchical resource-management scheme may be used to manage other types of resources.

In FIG. 2, a hierarchical resource-management system 200 includes resources organized into a hierarchy comprising higher-level resources 202 and lower-level resources 204. Higher-level resources 202 may be managed by a set of higher-level credit-management circuits 206, with each credit-management circuit configured to manage a particular higher-level resource. In some aspects, higher-level resources 202 may include various resources(e.g., packet buffers) that can be managed directly at the top level of the function processing the host-side commands. For example, a top-level outbound transfer engine (OXE) function of the NIC may include a message-chopping logic that can fragment a large message into packets of sizes corresponding to a maximum transmission unit (MTU). In alternative aspects, the resources may be arbitrarily grouped into multiple levels. In general, resources related to earlier stages of a processing pipeline may be placed into the higher level of the resource-management hierarchy. In some examples, a respective credit-management circuit in higher-level credit-management circuits 206 may be similar to credit-management circuit 100 shown in FIG. 1 and may be used to track the credit consumption of the various traffic classes.

Lower-level resources 204 may be managed by a set of lower-level credit-management circuits 206, with each credit-management circuit configured to manage a particular lower-level resource. In some aspects, lower-level resources 204 may include various DMA resources that can be managed locally at the lower level of the OXE function. The lower level of the OXE function may include address translation and tracking DMA instructions. In general, resources related to later stages of a processing pipeline may be placed into the lower level of the resource-management hierarchy. In some examples, a respective credit-management circuit in lower-level credit-management circuits 208 may be similar to credit-management circuit 100 shown in FIG. 1 and may be used to track the credit consumption of the various traffic classes.

In the example shown in FIG. 2, host-side commands may be queued in a command queue 210, and a higher-level arbitration circuit 212 may make an arbitration decision to select a command to send to a command-processing unit 214. The processed command may then be sent to a set of fixed-sized per-TC queues 216. More specifically, commands mapped to a particular TC may be queued into a queue corresponding to that particular TC.

A lower-level arbitration circuit 218 may then make an arbitration decision to select a processed command from per-TC queues to send to a DMA-processing unit 220, which may output a plurality of DMA operations that would consume various DMA resources (e.g., lower-level resources 204). Results of the DMA operations (e.g., the payloads of request packets) may be placed in a packet buffer, which is part of higher-level resources 202.

When higher-level arbitration circuit 212 makes an arbitration decision on the commands in command queue 210, it has no way of predicting how much lower-level or DMA resources would be needed. For example, a command may be an S-G DMA command requiring datatype or S-G DMA processing, and higher-level arbitration circuit 212 would not know how many DMA instructions may result from the S-G DMA command. However, the inclusion of fixed-sized per-TC queues 216 between higher-level arbitration circuit 212 and lower-level arbitration circuit 218 may ensure that the lower-level resource consumption is controlled locally, i.e., by lower-level credit-management circuit 208. More specifically, higher-level arbitration circuit 212 may simply view fixed-sized per-TC queues 216 as a higher-lever resource managed by higher-level credit-management circuits 206. When higher-level arbitration circuit 212 makes an arbitration decision for a command mapped to a particular TC, in addition to a predetermined arbitration algorithm (e.g., round robin), it may consider whether the resources managed by higher-level credit-management circuits 206, including higher-level resources 202 and fixed-sized per-TC queues 216, have credits available for that particular TC. If the particular TC runs out of credit in any resource managed by higher-level credit-management circuits, the corresponding command will not advance to command-processing unit 214. This way, the complexity of resource management at the lower level (e.g., by lower-level credit-management circuits 208) is hidden from the higher level.

In some aspects, lower-level arbitration circuit 218 may implement a dynamically weighted scheme (e.g., dynamically weighted round robin). More specifically, arbitration among fixed-sized per-TC queues 216 may give higher priority to fuller queues (i.e., queuing with more entries than other queues), thus ensuring consumption of lower-level resources 204 generally corresponds to the arbitration decisions made by higher-level arbitration circuit 212 (because the status of per-TC queues 216 may typically reflect the preference of higher-level arbitration circuit 212).

The example shown in FIG. 2 demonstrates the principle of operation of the hierarchical resource-management scheme. In this example, the resources are organized into two hierarchical levels, and resources in each level are managed locally, with the outputs of the local credit-management circuits sent to the local arbitration circuit. Moreover, a fixed-sized queuing structure (e.g., a set of fixed-sized per-TC queues) may be introduced at the boundary of the two hierarchy levels, positioned between the arbitration circuits. Such a fixed-sized queuing structure may be managed as a higher-level resource, thus hiding the complexity of the lower-lever resource management from the higher level. Although FIG. 2 shows two levels, in practice, resources in a system (e.g., a NIC) may be organized and managed in a hierarchy structure comprising more than two levels (e.g., three or four levels).

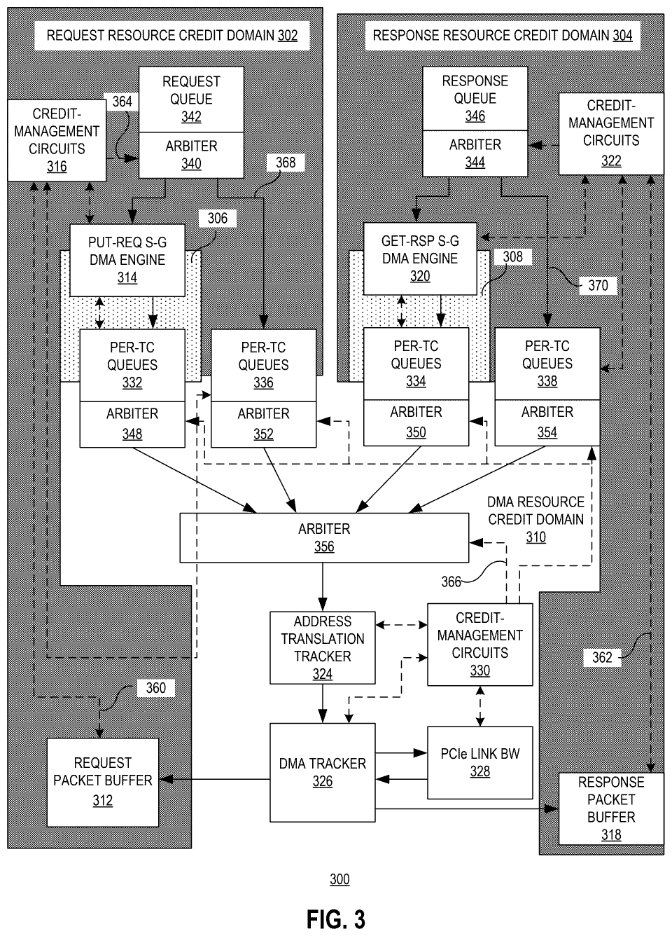

FIG. 3 illustrates an example of managing various resources on a network interface card (NIC) hierarchically, according to one aspect of the instant disclosure. In FIG. 3, a system 300 may be part of the outbound transfer engine (OXE) function of the NIC and may be divided into a plurality of resource credit domains based on the type of resources being managed in each domain, including a request resource credit domain 302, a response resource credit domain 304, a request datatype resource credit domain 306, a response datatype resource credit domain 308, and a DMA resource credit domain 310. In some aspects, request resource credit domain 302 and response resource credit domain 304 may be considered as the higher level of the resource-management hierarchy, whereas the other domains (e.g., domains 306-308) may be considered as the lower level of the hierarchy. For simplicity of illustration, only the resources and arbitration points (e.g., arbiters) of the OXE function are shown in FIG. 3, whereas the various processing logic units (e.g., command processing logics and logics for processing datatype/S-G DMA instructions) are omitted from FIG. 3.

Request resource credit domain 302 may include various resources associated with request commands/packets (e.g., PUT-requests) that can be managed directly at the top level (or earlier stages) of the OXE function. In FIG. 3, resources in request resource credit domain 302 may include at least a request packer buffer 312 and a tracker in PUT-request S-G DMA engine 314. In some examples, the system supports eight request TCs, and request packer buffer 312 may include 2048 cells for buffering packets mapped to the eight request TCs. Additional resources in request resource credit domain 302 may include multiple packet-connection-tracking (PCT) structures (not shown in FIG. 3) associated with the requests. The various resources in request resource credit domain 302 may be managed by credit-management circuits 316, one circuit per resource.

Response resource credit domain 304 may include various resources associated with response commands/packets (e.g., GET-responses). Resources in response resource credit domain 304 may include at least a response packer buffer 318 and a tracker in GET-response S-G DMA engine 320. In some examples, the system supports six response TCs, and response packer buffer 318 may include 2048 cells for buffering packets mapped to the six response TCs. The various resources in response resource credit domain 304 may be managed by credit-management circuits 322, one circuit per resource.

Request datatype resource credit domain 306 is a resource management domain within the PUT-request S-G DMA engine 314, and response datatype resource credit domain 308 is a resource management domain within the GET-response S-G DMA engine 320.

DMA resource credit domain 310 may include various DMA resources, such as an address translation tracker 324, a DMA tracker 326, and PCIe link bandwidth 328. Address translation tracker 324 may temporarily hold DMA instructions that wait for address translation (i.e., the translation that maps a virtual address to a physical address in the local host memory or remote memory). DMA tracker 326 may temporarily hold DMA read or write operations to be issued to the host side or the fabric side. PCIe link bandwidth 328 may provide bandwidth needed for each DMA data operation (i.e., a read or write operation). These DMA resources may be managed by credit-management circuits 330, one circuit per resource. Moreover, the DMA resources may be used by all DMA instructions from the request and response pipelines.

When S-G DMA processing is implemented, credit resource domain 306 or 308 may be an intermediate domain between request resource credit domain 302 or response resource credit domain 304, respectively, and DMA resource credit domain. More specifically, the tracker in PUT-request S-G DMA engine 314 is positioned at the boundary between request resource credit domain 302 and request datatype resource credit domain 306 and is viewed as a resource in request resource credit domain 302 (i.e., it is managed by a circuit in credit-management circuits 316). In addition, a set of fixed-sized per-TC queues 332 is positioned at the boundary between request datatype resource credit domain 306 and DMA resource credit domain 310 and is viewed as a resource in request datatype resource credit domain 306. In this situation, fixed-sized per-TC queues 332 may be managed by a lightweight credit-management circuit (not shown in FIG. 3) embedded in PUT-request S-G DMA engine 314. In some examples, the tracker in PUT-request S-G DMA engine 314 may include 256 entries that may be mapped to eight request TCs, and each of the fixed-sized per-TC queues 332 may include 32 entries.

Similarly, the tracker in GET-response S-G DMA engine 320 is positioned at the boundary between response resource credit domain 304 and response datatype resource credit domain 308 and is viewed as a resource in response resource credit domain 304 (i.e., it is managed by a circuit in credit-management circuits 322); a set of fixed-sized per-TC queues 334 is positioned at the boundary between response datatype resource credit domain 308 and DMA resource credit domain 310 and is viewed as a resource in response datatype resource credit domain 308. Fixed-sized per-TC queues 334 may be managed by a lightweight credit-management circuit (not shown in FIG. 3) embedded in GET-response S-G DMA engine 320. In some examples, the tracker in GET-response S-G DMA engine 320 may include 256 entries that may be mapped to six response TCs, and each of the fixed-sized per-TC queues 334 may include 32 entries.

When S-G DMA processing is bypassed, a set of fixed-sized per-TC queues 336 (which may be similar to the set of per-TC queues 332) is positioned at the boundary between request resource credit domain 302 and DMA resource credit domain 310 and is viewed as a resource in request resource credit domain 302 (i.e., it is managed by a circuit in credit-management circuits 316); a set of fixed-sized per-TC queues 338 (which may be similar to the set of per-TC queues 334) is positioned at the boundary between response resource credit domain 304 and DMA resource credit domain 310 and is viewed as a resource in response resource credit domain 304 (i.e., managed by a circuit in credit-management circuits 322). In FIG. 3, the dashed double arrows (e.g., arrows 360 and 362) indicate the connections between the resources and the credit-management circuits controlling the resources, the dashed single arrows (e.g., arrows 364 and 366) indicate the connections between the credit-management circuits and the various arbitration points, and the solid arrows (e.g., arrows 368 and 370) indicate the direction of the command-processing pipeline where results of a previous stage are sent to the next stage for further processing/operation.

Outputs of the credit-management circuits (e.g., the credit-available output of all TCs) may be sent to the arbitration points within the corresponding hierarchy level, as indicated by the dashed single arrows. For example, the outputs of credit-management circuits 316 in request resource credit domain 302 are sent to arbiter 340, as indicated by arrow 364. Arbiter 340 may then make an arbitration decision based on the credit information associated with each TC for each resource in request resource credit domain 302. A command in request queue 342 will not win arbitration if it is mapped to a TC that does not have sufficient credits in all resources within request resource credit domain 302. Similarly, outputs of credit-management circuits 322 in response resource credit domain 304 are sent to arbiter 344, which may then make an arbitration decision based on the credit information associated with each TC for each resource in response resource credit domain 304. A command in response queue 346 will not win arbitration if it is mapped to a TC that does not have sufficient credits in all resources within response resource credit domain 304.

In DMA resource credit domain 310, the outputs of credit-management circuits 330 may be sent to arbiters 348, 350, 352, 354, and 356. For example, arrow 366 indicates that the outputs of credit-management circuits 330 are sent to arbiter 356. As discussed previously, the DMA resources (e.g., address translation tracker 324, DMA tracker 326, and PCIe link bandwidth 328) are used by all instructions in the request and response pipelines, including those with datatype processing and those without. For requests/responses with datatype processing, arbiter 348/350 may select a queue from per-TC queues 332/334, respectively, to dequeue. For requests/responses without datatype processing, arbiter 352/354 may select a queue from per-TC queues 336/338, respectively, to dequeue.

In some aspects, to ensure the fair use of the DMA resources by all four sources of the DMA instructions (i.e., functions which enqueue to the four sets of fixed-sized per-TC queues 332 to 338), each credit-management circuit in circuits 330 may be configured to share the resource among 30 TCs, including eight datatype request TCs, six datatype response TCs, eight non-datatype request TCs, and six non-datatype response TCs. In some examples, address translation tracker 324 may include 256 entries, and DMA tracker 326 may include 4096 entries. These entries may be mapped to the above 30 TCs. Similarly, PCIe link bandwidth 328 may include a plurality of bandwidth units that to be shared among the 30 TCs. Each of the four sources of DMA instructions is unaware of the lower-level complexity of the resource management and simply interfaces with the DMA resource credit domain 310 via its own set of simple, fixed-size, per-TC queues. An arbiter 356 may arbitrate access to the DMA resources by the four sources of the DMA instructions.

It may be common to see an imbalance in the number of DMA operations requested by each TC or from each source. In some aspects, arbiter 356 may implement a dynamically weighted arbitration scheme (e.g., dynamically weighted round robin) such that arbitration among the queues feeding into DMA resource credit domain 310 gives higher priority to fuller queues (e.g., a queue with more entries than other queues). This ensures that the consumption of DMA resources generally corresponds to the higher-level arbitration decisions (e.g., decisions made by arbiters 340 and 344) while also preventing starvation of any given TC.

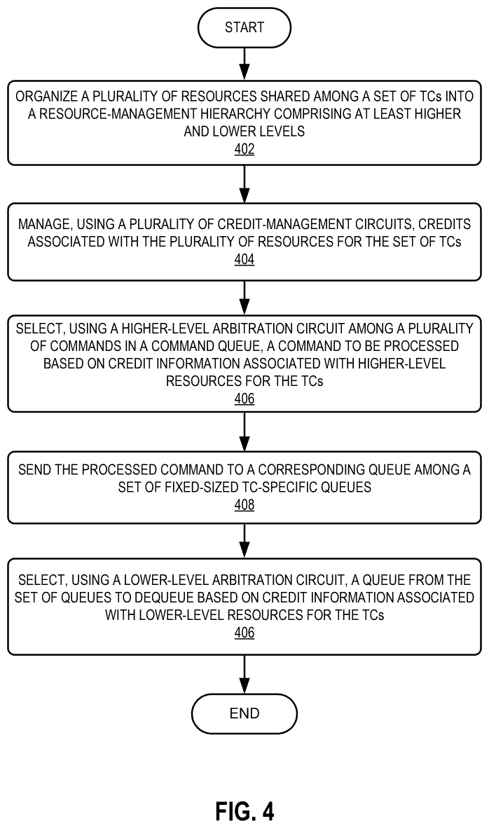

FIG. 4 presents a flowchart illustrating an example process for managing a plurality of resources on a network interface controller (NIC), according to one aspect of the instant disclosure. During operation, the system may organize the plurality of resources shared by a set of TCs into a resource-management hierarchy comprising at least higher and lower levels (operation 402). In some aspects, depending on whether the resources are related to the processing of requests, responses, or DMA instructions, the resources may also be organized into the request domain, the response domain, and the DMA domain. In further aspects, the request and response domain may be at the higher level of the resource hierarchy, whereas the DMA domain may be at the lower level. Moreover, when datatype (or S-G DMA) processing is needed, PUT-request and GET-response datatype domains may also be included in the hierarchy.

The system may manage, using a plurality of credit-management circuits, credits associated with the plurality of resources for the set of TCs (operation 404). More specifically, each resource may be managed by a corresponding credit-management circuit, which may be similar to credit-management circuit 100 shown in FIG. 1. Outputs of the credit-management circuit may provide credit information (e.g., whether credits are available) for the different TCs. Resources in a particular hierarchy level may be managed by credit-management circuits within the same level. For example, a lower-level resource may be managed by a corresponding lower-level credit-management circuit, and a higher-level resource may be managed by a corresponding higher-level credit-management circuit.

The system may select, using a higher-level arbitration circuit among a plurality of commands in a command queue, a command to process based on credit information associated with higher-level resources for the TCs (operation 406). Processing the command may consume one or more higher-level resources (e.g., request packet buffer 312 or response packet buffer 318 shown in FIG. 3). The system may send the processed command to a corresponding queue among a set of fixed-sized TC-specific queues (operation 408). If the command is mapped to a particular TC, the system may send the processed command to a queue specific to that particular TC. The command may be a request command or response command, and the command may require datatype processing or bypass datatype processing. Depending on the type of command, the system may send the processed command to one of the four sets of fixed-sized per-TC queues. Moreover, the fixed-size per-TC queues may be viewed as a higher-level resource managed by a higher-level credit-management circuit. Credit information associated with the fixed-sized per-TC queues for the different TCs may be fed to the higher-level arbitration circuit to make the arbitration decision.

The system may further select, using a lower-level arbitration circuit, a queue from the set of queues to dequeue based on credit information associated with lower-level resources for the TCs (operation 410). The dequeued entry may advance to the next processing stage, which may involve consuming the lower-level resources. In some aspects, the lower-level resources may include DMA resources. In some aspects, the lower-level arbitration circuit may implement a dynamically weighted arbitration scheme (e.g., dynamically weighted round robin) to give a higher priority to fuller queues among the set of fixed-sized TC-specific queues.

Although the example processes in FIG. 4 show a specific order of performing certain operations, the processes are not limited to such an order. Operations shown in succession in the flowchart may be performed in a different order and may be executed concurrently or with partial concurrence or combinations thereof.

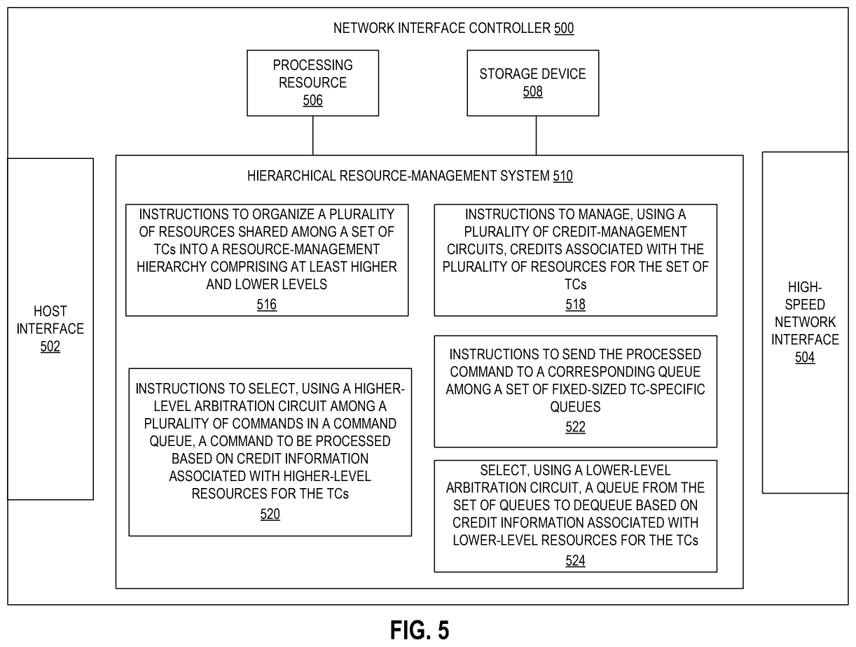

FIG. 5 illustrates an example network interface controller (NIC), according to one aspect of the instant application. NIC 500 may be part of a compute node to provide network connectivity to the compute node. A compute node may include one or more NICs. In some examples, a compute node may include one, two, four, or eight NICs. NIC 500 may include fewer or more entities than those shown in FIG. 5. In the example shown in FIG. 5, a NIC 500 may include at least a host interface (HI) 502 and a high-speed network interface (HNI) 504.

HI 502 may include a peripheral component interconnect (PCI) or a peripheral component interconnect express (PCIe) interface and may be coupled to the host via a host connection with multiple lanes (e.g., PCIe Gen 4 lanes capable of operating at signaling rates up to 25 Gbps per lane). HNI 504 may facilitate a high-speed network connection for communicating with a link in the switch fabric.

NIC 500 may include one or more processing resources (e.g., processing resource 506), one or more storage devices (e.g., storage device 508), and a hierarchical resource-management system 510. In this example, storage device 508 may include volatile storage as well as non-volatile storage.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium (e.g., storage device 408) to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution.

Hierarchical resource-management system 510 may include any number of software components, hardware components, and firmware components that work together to achieve the goal of managing a plurality of resources on NIC 500. In some aspects, hierarchical resource-management system 510 may include computer instructions, which, when executed by processing resource 506, may cause processing resource 506 to perform methods and/or processes described in this disclosure. Specifically, hierarchical-resource-management system 510 may include instructions 516 to organize the plurality of resources shared by a set of TCs into a resource-management hierarchy comprising at least higher and lower levels, as described above in relation to operation 402 shown in FIG. 4. In some aspects, the resource hierarchy may be similar to the one shown in FIG. 3 and may include a plurality of resource credit domains.

Hierarchical resource-management system 510 may include instructions 518 to manage, using a plurality of credit-management circuits, credits associated with the plurality of resources for the set of TCs, as described above in relation to operation 404 shown in FIG. 4. Each credit-management circuit may be similar to circuit 100 shown in FIG. 1 and may include a plurality of credit-take and credit-return interfaces to allow different consumers of a resource to take and return credits.

Hierarchical resource-management system 510 may include instructions 520 to select, using a higher-level arbitration circuit among a plurality of commands in a command queue, a command to process based on credit information associated with higher-level resources for the TCs, as described above in relation to operation 406 shown in FIG. 4. A command mapped to a TC without sufficient credits in any of the higher-level resources would not be selected. In some aspects, the command may be associated with a request or a response.

Hierarchical resource-management system 510 may include instructions 522 to send the processed command to a corresponding queue among a set of fixed-sized TC-specific queues, as described above in relation to operation 408 shown in FIG. 4. Processing the command may or may not involve datatype (or S-G DMA) processing. Depending on the type of command, the processed command may be sent to one of four sets of fixed-sized TC-specific queues (e.g., queue sets 332-338 shown in FIG. 3). The sets of fixed-sized TC-specific queues may be treated as higher-level resources, and their credit information may be considered by the higher-level arbitration circuit when it makes an arbitration decision.

Hierarchical resource-management system 510 may include instructions 524 to select, using a lower-level arbitration circuit, a queue from the set of queues to dequeue based on credit information associated with lower-level resources for the TCs, as described above in relation to operation 410 shown in FIG. 4. In some embodiments, the lower-level arbitration circuit may implement a dynamically weighted arbitration scheme (e.g., dynamically weighted round robin) that gives higher priority to fuller queues, thus ensuring that the lower-level arbitration decisions may follow the higher-level arbitration decisions.

NIC 500 may include fewer or more entities than those shown in FIG. 5. For example, NIC 500 may include instructions to perform datatype or S-G DMA processing. NIC 500 may further include instructions to perform address translations.

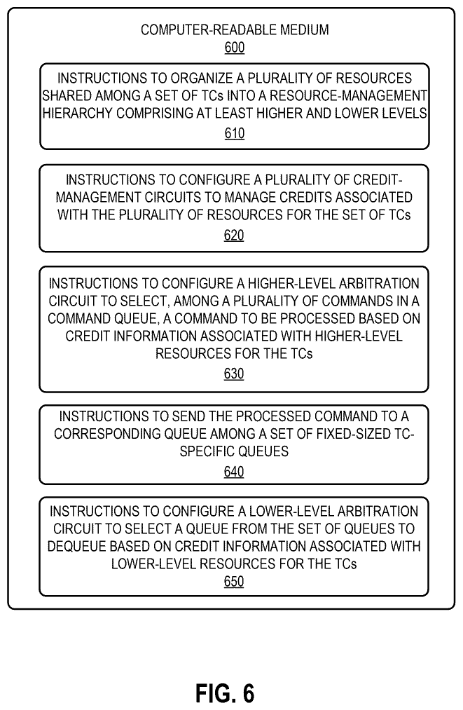

FIG. 6 illustrates a computer-readable medium that facilitates the operation of the hierarchical-resource-management system, according to one aspect of the instant application. CRM 600 may be a non-transitory computer-readable medium or device storing computer functions that when executed by a computer or processing resource cause the computer or processing resource to perform a method. As used herein, a “computer-readable storage medium” may be any electronic, magnetic, optical, or other physical storage apparatus to contain or store information such as executable codes, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 600 may store instructions 610 to organize the plurality of resources shared by a set of TCs into a resource-management hierarchy comprising at least higher and lower levels, as described above in relation to operation 402 shown in FIG. 4; instructions 620 to configure a plurality of credit-management circuits to manage credits associated with the plurality of resources for the set of TCs, as described above in relation to operation 404 shown in FIG. 4; instructions 630 to configure a higher-level arbitration circuit to select, among a plurality of commands in a command queue, a command to process based on credit information associated with higher-level resources for the TCs, as described above in relation to operation 406 shown in FIG. 4; instructions 640 to send the processed command to a corresponding queue among a set of fixed-sized TC-specific queues, as described above in relation to operation 408 shown in FIG. 4; and instructions 650 to configure a lower-level arbitration circuit to select a queue from the set of queues to dequeue based on credit information associated with lower-level resources for the TCs, as described above in relation to operation 410 shown in FIG. 4.

CRM 600 may store more codes than those shown in FIG. 6. For example, CRM 600 may store instructions to perform datatype or S-G DMA processing and instructions to perform address translations.

In general, aspects of the disclosure solve the technical problem of efficiently managing various resources on a NIC supporting S-G DMA operations to ensure fair access to the resources by different TCs. Different types of resources (e.g., packet buffers, trackers, etc.) on the NIC may be grouped into different resource domains (e.g., request resource credit domain, response resource credit domain, DMA resource domain, etc.). These different resource domains may be managed in a hierarchy of multiple levels. Resource management at a lower hierarchy level may be hidden from the higher level by implementing a set of fixed-sized per-TC queues at the interface between the two levels. Each resource may be managed by a credit-management circuit, which includes a number of “take” and “return” interfaces corresponding to different command-processing stages (or control functions), where each stage or function may take or return a certain number of credits. The credit-management circuit may receive, from configuration software, inputs that specify the total number of credits for the resource, the number of credits reserved for each TC, and the credit limit for each TC. The credit-management circuit may also output, for each TC, a credit available signal and a throttle signal.

One aspect may provide a resource-management system for managing resources to be shared among a set of traffic classes on a network interface card (NIC). The system may include a resource-management hierarchy comprising at least higher and lower levels of resources, a plurality of credit-management circuits, a respective credit-management circuit to manage credits associated with a resource for the set of traffic classes, and a command queue comprising a plurality of to-be-processed commands mapped to the set of traffic classes. The system may further include a higher-level arbitration circuit to select, among the plurality of to-be-processed commands, a command to process based on credit information associated with the higher-level resources for the set of traffic classes, processing the command to consume one or more higher-level resources, a set of fixed-sized traffic-class-specific queues corresponding to the set of traffic classes to queue processed commands, and a lower-level arbitration circuit to select a queue from the set of fixed-sized traffic-class-specific queues to dequeue for next-stage processing based on credit information associated with the lower-level resources for the set of traffic classes, the next-stage processing to consume one or more lower-level resources.

In a variation on this aspect, the higher-level resources comprise the set of fixed-sized traffic-class-specific queues.

In a further variation, the higher-level resources may further include a packet buffer, and the lower-level resources may include resources used by direct memory access (DMA) operations.

In a variation on this aspect, the lower-level arbitration circuit is to apply a dynamically weighted arbitration scheme to provide priority to a queue with more entries than other queues.

In a variation on this aspect, the higher-level resources are divided into a request domain and a response domain, each domain corresponding to a domain-specific command queue.

In a variation on this aspect, the respective credit-management circuit may include one or more credit-take interfaces and one or more credit-return interfaces corresponding to one or more consumers of the resource, and a respective consumer is to obtain credits speculatively from a corresponding credit-take interface and to return unused credits via a corresponding credit-return interface.

In a further variation, a respective credit-take or credit-return interface may include a traffic-class input specifying a traffic class and a credit-amount input specifying a count of credits to be taken or returned, respectively.

In a further variation, the credit-management circuit may include a credit-accounting subcircuit to track credits in a shared credit pool and a set of traffic-class-specific reserved pools.

In a further variation, the credit-accounting sub-circuit is to output, based on the tracked credits, a credit-available signal indicating whether credits are available for a corresponding traffic class.

One aspect of the instant disclosure may provide a method for managing a plurality of resources on a network interface controller (NIC). The method may include organizing the plurality of resources into a resource-management hierarchy comprising at least higher and lower levels of resources; managing, using a plurality of credit-management circuits, credits associated with the plurality of resources for the set of traffic classes; selecting, by a higher-level arbitration circuit, a command in a command queue comprising a plurality of to-be-processed commands mapped to the set of traffic classes to process based on credit information associated with the higher-level resources for the set of traffic classes, processing the command consumes one or more higher-level resources; queuing the processed command into a corresponding queue in a set of fixed-sized traffic-class-specific queues corresponding to the set of traffic classes; and selecting, by a lower-level arbitration circuit, a queue from the set of fixed-sized traffic-class-specific queues to dequeue for next-stage processing based on credit information associated with the lower-level resources for the set of traffic classes, the next-stage processing to consume one or more lower-level resources.

In this disclosure, the circuits include a plurality of logic units capable of performing predetermined logic functions described throughout the disclosure. The circuits and subcircuits shown in FIGS. 1-3 may be implemented using any form of hardware, software, firmware, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate functions, these features and functionality can be shared among one or more common functions, and such description shall not require or imply that separate circuits are required to implement such features or functionality.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A resource-management system for managing resources to be shared among a set of traffic classes on a network interface card (NIC), the system comprising:
a resource-management hierarchy comprising at least higher and lower levels of resources;
a plurality of credit-management circuits, a respective credit-management circuit to manage credits associated with a resource for the set of traffic classes;
a command queue comprising a plurality of to-be-processed commands mapped to the set of traffic classes;
a higher-level arbitration circuit to select, among the plurality of to-be-processed commands, a command to process based on credit information associated with the higher-level resources for the set of traffic classes, processing the command to consume one or more higher-level resources;
a set of fixed-sized traffic-class-specific queues corresponding to the set of traffic classes to queue processed commands; and
a lower-level arbitration circuit to select a queue from the set of fixed-sized traffic-class-specific queues to dequeue for next-stage processing based on credit information associated with the lower-level resources for the set of traffic classes, the next-stage processing to consume one or more lower-level resources.

2. The resource-management system of claim 1, wherein the higher-level resources comprise the set of fixed-sized traffic-class-specific queues.

3. The resource-management system of claim 2, wherein the higher-level resources further comprise a packet buffer, and wherein the lower-level resources comprise resources used by direct memory access (DMA) operations.

4. The resource-management system of claim 1, wherein the lower-level arbitration circuit is to apply a dynamically weighted arbitration scheme to provide priority to a queue with more entries than other queues.

5. The resource-management system of claim 1, wherein the higher-level resources are divided into a request domain and a response domain, each domain corresponding to a domain-specific command queue.

6. The resource-management system of claim 1, wherein the respective credit-management circuit comprises one or more credit-take interfaces and one or more credit-return interfaces corresponding to one or more consumers of the resource, and wherein a respective consumer is to obtain credits speculatively from a corresponding credit-take interface and to return unused credits via a corresponding credit-return interface.

7. The resource-management system of claim 6, wherein a respective credit-take or credit-return interface comprises a traffic-class input specifying a traffic class and a credit-amount input specifying a count of credits to be taken or returned, respectively.

8. The resource-management system of claim 6, wherein the credit-management circuit comprises a credit-accounting subcircuit to track credits in a shared credit pool and a set of traffic-class-specific reserved pools.

9. The resource-management system of claim 8, wherein the credit-accounting sub-circuit is to output, based on the tracked credits, a credit-available signal indicating whether credits are available for a corresponding traffic class.

10. A method for managing a plurality of resources on a network interface controller (NIC), the method comprising:
organizing the plurality of resources into a resource-management hierarchy comprising at least higher and lower levels of resources;
managing, using a plurality of credit-management circuits, credits associated with the plurality of resources for the set of traffic classes;
selecting, by a higher-level arbitration circuit, a command in a command queue comprising a plurality of to-be-processed commands mapped to the set of traffic classes to process based on credit information associated with the higher-level resources for the set of traffic classes, processing the command consumes one or more higher-level resources;
queuing the processed command into a corresponding queue in a set of fixed-sized traffic-class-specific queues corresponding to the set of traffic classes; and
selecting, by a lower-level arbitration circuit, a queue from the set of fixed-sized traffic-class-specific queues to dequeue for next-stage processing based on credit information associated with the lower-level resources for the set of traffic classes, the next-stage processing to consume one or more lower-level resources.

11. The method of claim 10, wherein the higher-level resources comprise the set of fixed-sized traffic-class-specific queues.

12. The method of claim 11, wherein the higher-level resources further comprise a packet buffer, and wherein the lower-level resources comprise resources used by direct memory access (DMA) operations.

13. The method of claim 10, wherein selecting the queue comprises applying a dynamically weighted arbitration scheme to provide priority to a queue with more entries than other queues.

14. The method of claim 10, wherein the higher-level resources are divided into a request domain and a response domain, each domain corresponding to a domain-specific command queue.

15. The method of claim 10, wherein the respective credit-management circuit comprises one or more credit-take interfaces and one or more credit-return interfaces corresponding to one or more consumers of the resource, and wherein a respective consumer is to obtain credits speculatively from a corresponding credit-take interface and to return unused credits via a corresponding credit-return interface.

16. The method of claim 15, wherein a respective credit-take or credit-return interface comprises a traffic-class input specifying a traffic class and a credit-amount input specifying a count of credits to be taken or returned, respectively.

17. The method of claim 15, wherein the credit-management circuit comprises a credit-accounting subcircuit to track credits in a shared credit pool and a set of traffic-class-specific reserved pools.

18. The method of claim 17, wherein the credit-accounting sub-circuit is to output, based on the tracked credits, a credit-available signal indicating whether credits are available for a corresponding traffic class.

19. A non-transitory computer-readable storage medium storing instructions to:
organize a plurality of resources on a network interface controller (NIC) into a resource-management hierarchy comprising at least higher and lower levels of resources;
configure a plurality of credit-management circuits to manage credits associated with the plurality of resources for the set of traffic classes;
configure a higher-level arbitration circuit to select a command in a command queue comprising a plurality of to-be-processed commands mapped to the set of traffic classes to process based on credit information associated with the higher-level resources for the set of traffic classes, processing the command consumes one or more higher-level resources;
queue the processed command into a corresponding queue in a set of fixed-sized traffic-class-specific queues corresponding to the set of traffic classes; and
configure a lower-level arbitration circuit to select a queue from the set of fixed-sized traffic-class-specific queues to dequeue for next-stage processing based on credit information associated with the lower-level resources for the set of traffic classes, the next-stage processing to consume one or more lower-level resources.

20. The non-transitory computer-readable storage medium of claim 19, wherein the respective credit-management circuit comprises one or more credit-take interfaces and one or more credit-return interfaces corresponding to one or more consumers of the resource, and wherein a respective consumer is to speculatively obtain credits from a corresponding credit-take interface and to return unused credits via a corresponding credit-return interface.
